(19) United States
(12) Patent Application Publication
(10) Pub. No.: US 2021/0281492 A1
(43) Pub. Date: Sep. 9, 2021

(54) DETERMINING CONTEXT AND ACTIONS FOR MACHINE LEARNING-DETECTED NETWORK ISSUES

(71) Applicant: Cisco Technology, Inc., San Jose, CA (US)

(72) Inventors: Andrea Di Pietro, Lausanne (CH); Javier Cruz Mota, Lussy-sur-Morges (CH); Sukrit Dasgupta, Norfolk, MA (US); Jean-Philippe Vasseur, Saint Martin D'uriage (FR)

(21) Appl. No.: 16/812,517

(22) Filed: Mar. 9, 2020

(51) Int. Cl. H04L 12/24; G06N 20/00

(52) U.S. Cl. CPC H04L 41/16; G06N 20/00; H04L 41/0631

(57) ABSTRACT

In one embodiment, a network assurance service that monitors a network detects a network issue in the network using a machine learning model and based on telemetry data captured in the network. The service assigns the detected network issue to an issue cluster by applying clustering to the detected network issue and to a plurality of previously detected network issues. The service selects a set of one or more actions for the detected network issue from among a plurality of actions associated with the previously detected network issues in the issue cluster. The service obtains context data for the detected network issue. The service provides, to a user interface, an indication of the detected network issue, the obtained context data for the detected network issue, and the selected set of one or more actions.

### TECHNICAL FIELD

The present disclosure relates generally to computer networks, and, more particularly, to determining context and actions for machine learning-detected network issues.

### BACKGROUND

Networks are large-scale distributed systems governed by complex dynamics and very large number of parameters. In general, network assurance involves applying analytics to captured network information, to assess the health of the network. For example, a network assurance service may track and assess metrics such as available bandwidth, packet loss, jitter, and the like, to ensure that the experiences of users of the network are not impinged. However, as networks continue to evolve, so too will the number of applications present in a given network, as well as the number of metrics available from the network.

Recent advancements in the field of machine learning now make it possible to forecast and detect network issues using machine learning models that assess the behavior of the network. However, network issues detected by a machine learning model can often be difficult to interpret for an end user, such as a network administrator. Indeed, while a machine learning model may be trained to detect abnormal and anomalous behaviors in the network, it is still left to the user to determine whether that behavior is actually problematic, the root cause of the behavior, and any corrective actions to be taken, if necessary.

### BRIEF DESCRIPTION OF THE DRAWINGS

FIGS. 1A-1B illustrate an example communication network;

FIG. 2 illustrates an example network device/node;

FIG. 3 illustrates an example network assurance system;

FIG. 4 illustrates an example architecture for determining context and actions for issues detected by a network assurance system; and

FIG. 5 illustrates an example simplified procedure for determining context and actions for machine learning-detected network issues.

### DESCRIPTION OF EXAMPLE EMBODIMENTS

### Overview

According to one or more embodiments of the disclosure, a network assurance service that monitors a network detects a network issue in the network using a machine learning model and based on telemetry data captured in the network. The service assigns the detected network issue to an issue cluster by applying clustering to the detected network issue and to a plurality of previously detected network issues. The service selects a set of one or more actions for the detected network issue from among a plurality of actions associated with the previously detected network issues in the issue cluster. The service obtains context data for the detected network issue. The service provides, to a user interface, an indication of the detected network issue, the obtained context data for the detected network issue, and the selected set of one or more actions.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

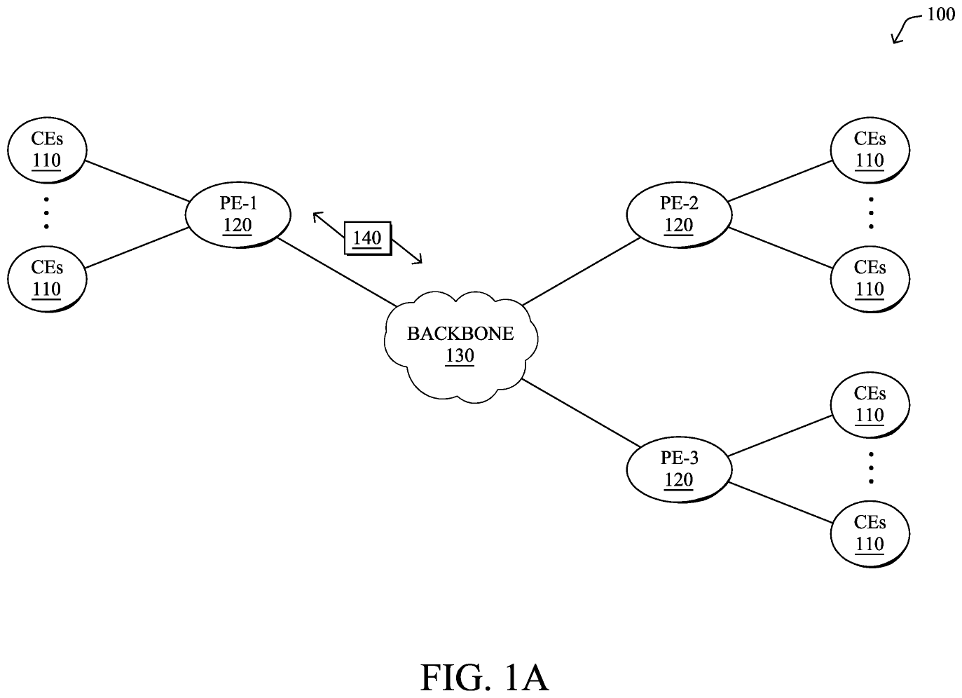

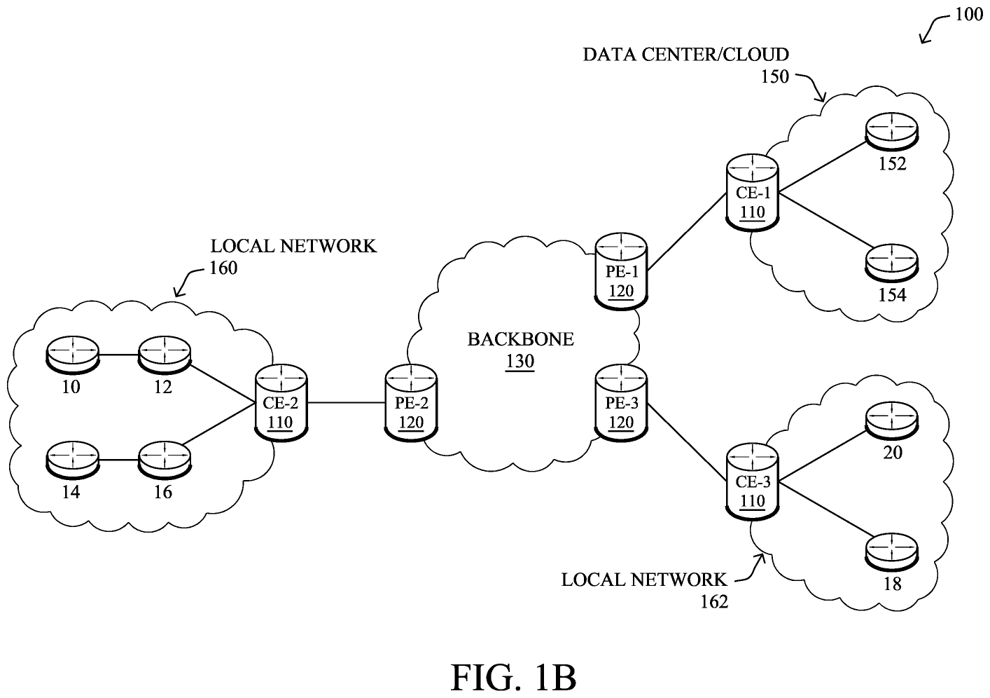

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

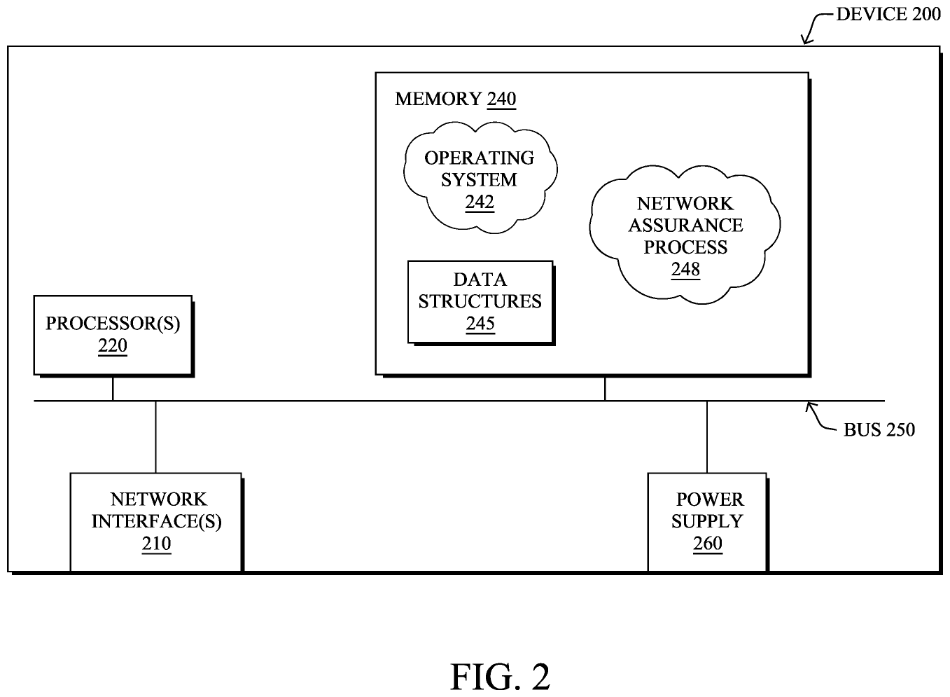

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason code to the assurance service. To evaluate a rule regarding these conditions, the network assurance service may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and/or to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

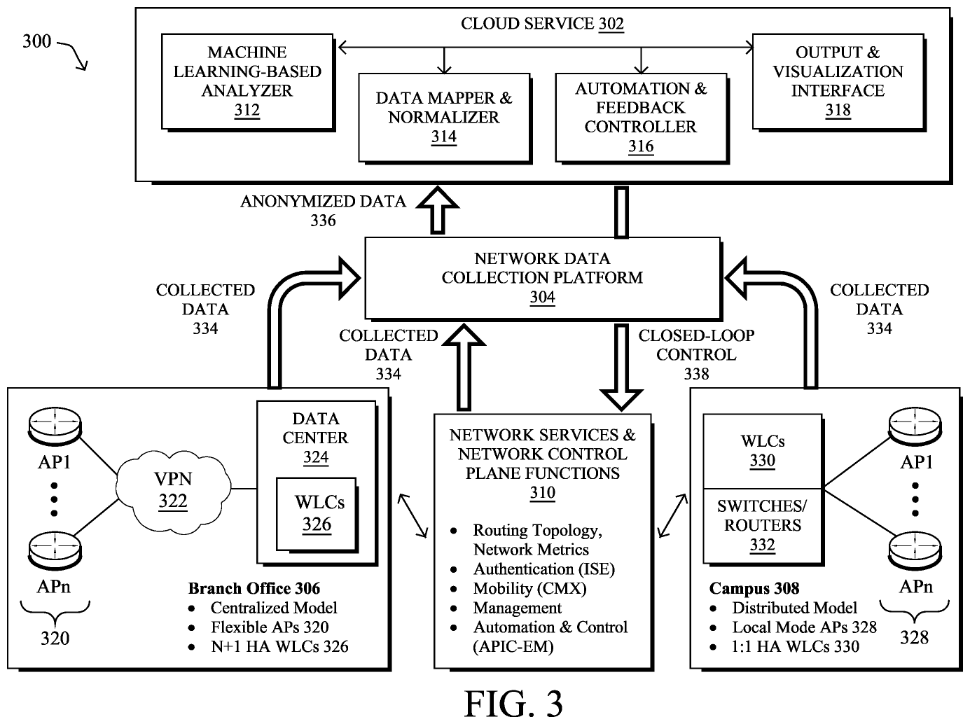

FIG. 3 illustrates an example network assurance system 300, according to various embodiments. As shown, at the core of network assurance system 300 may be a cloud-based network assurance service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point AP1 through nth access point, APn) through which endpoint nodes may connect. Access points 320 may, in turn, be in communication with any number of wireless LAN controllers (WLCs) 326 (e.g., supervisory devices that provide control over APs) located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point AP1 through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning (ML)-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:

Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc.). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).

Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.

Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint client device, networking device in branch office 306 or campus 308, or a network service or control plane function 310, to adjust its operations (e.g., by signaling an endpoint to use a particular AP 320 or 328, etc.).

As noted above, a network assurance system/service may leverage machine learning to detect anomalies and outlier behavior among a collection of networking entities (e.g., APs, AP controllers, switches, routers, tunnels, links, etc.) based on any number of observed measurements/key performance indicators (KPIs). These KPIs may include, for example, metrics like utilization, client count, throughput, traffic, loss, latency, jitter, onboarding times, or any other measurement from a network that can indicate an issue present in the network (e.g., an anomalous KPI, etc.).

Unfortunately, network issues detected by a machine learning model can often be difficult to interpret for the user. Even in cases in which the service also provides suggested actions to the user, these actions are typically statistically defined for each issue type (e.g., not tailored to the specific issue) and are not easily enforced (e.g., the user must still translate the suggested actions into actual commands).

### Determining Context and Actions for Machine Learning-Detected Network Issues

The techniques herein allow a network assurance service to determine both additional context and suggested actions, when it detects a network issue in a monitored network. In some aspects, a crowdsourcing mechanism is introduced herein to enhance the contextual data provided to a user when the service detects a network issue, based on feedback provided about similar issues that the service previously detected. In further aspects, the service can also suggest a set of actions to address the detected network issue. This selection can be performed dynamically by comparing the detected issues to the similar, previously detected issues, allowing the service to incrementally build a knowledge base. In further aspects, the user may be asked to provide feedback regarding the suggested action(s), allowing the service to automatically translate the action(s) into configuration data for the network and initiate performance of the action(s). Optionally, if the user demonstrates a high degree of trust in the suggested actions over time, the service can also enable a closed-loop control mechanism to automatically enforce selected actions in the network for network issues detected in the future.

Specifically, according to one or more embodiments of the disclosure as described in detail below, a network assurance service that monitors a network detects a network issue in the network using a machine learning model and based on telemetry data captured in the network. The service assigns the detected network issue to an issue cluster by applying clustering to the detected network issue and to a plurality of previously detected network issues. The service selects a set of one or more actions for the detected network issue from among a plurality of actions associated with the previously detected network issues in the issue cluster. The service obtains context data for the detected network issue. The service provides, to a user interface, an indication of the detected network issue, the obtained context data for the detected network issue, and the selected set of one or more actions.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

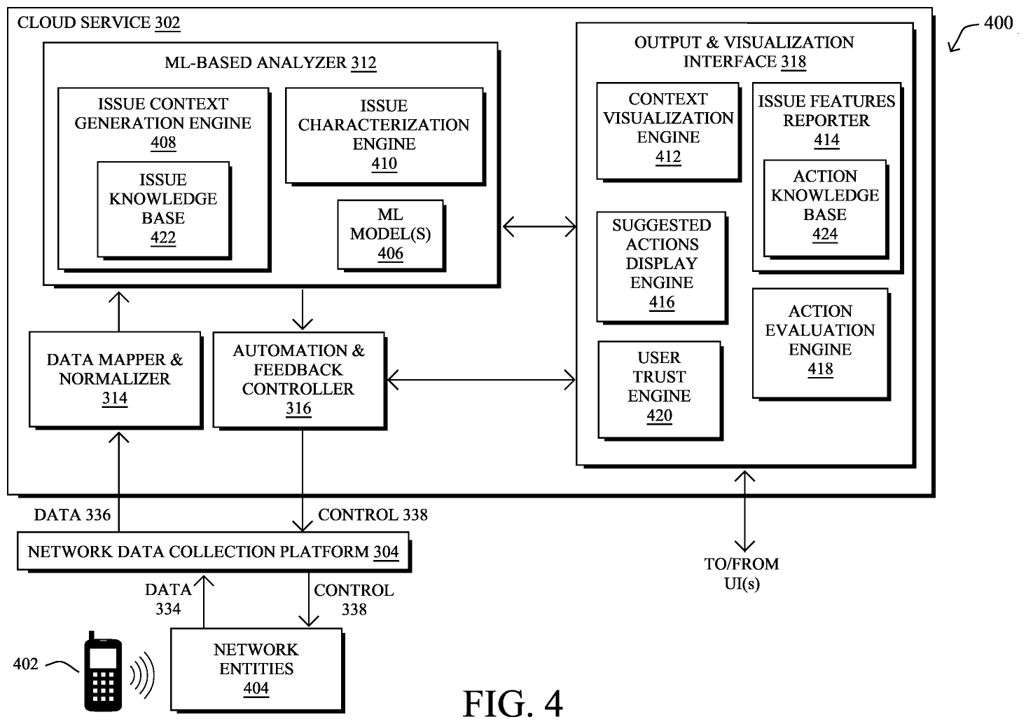

Operationally, FIG. 4 illustrates an example architecture 400 for determining context and actions for issues detected by a network assurance system, according to various embodiments. At the core of architecture 400 may be the following components: one or more machine learning (ML) models 406, an issue context generation engine 408, an issue characterization engine 410, a context visualization engine 412, an issue features reporter 414, a suggested actions display engine 416, an action evaluation engine 418, and/or a user trust engine 420. In some implementations, the components 406-420 of architecture 400 may be implemented within a network assurance system, such as system 300 shown in FIG. 3. Accordingly, the components 406-420 of architecture 400 shown may be implemented as part of cloud service 302 (e.g., as part of machine learning-based analyzer 312 and/or output and visualization interface 318), as part of network data collection platform 304, and/or on one or more network elements/entities 404 that communicate with one or more client devices 402 within the monitored network itself. Further, these components 406-420 may be implemented in a distributed manner or implemented as its own stand-alone service, either as part of the local network under observation or as a remote service. In addition, the functionalities of the components of architecture 400 may be combined, omitted, or implemented as part of other processes, as desired.

During operation, service 302 may receive telemetry data from the monitored network (e.g., anonymized data 336 and/or data 334) and, in turn, assess the data using one or more machine learning models 406. At the core of each machine learning model 406 may be a corresponding anomaly detection model, such as an unsupervised learning-based model, or other form of model that identifies network issues in the network of entities 404. For example, such a model may compare one or more KPIs indicated by data 334/336 for a particular network entity 404 to those of other network entities in the network and/or in other peer networks. In a further example, the model 406 may predict certain KPIs or other network behaviors and compare those to what is indicated by the received telemetry data 334/336. If the two values deviate by a predefined threshold, the model 406 may determine that an issue has been detected.

According to various embodiments, issue context generation engine 408 may be activated when a machine learning model 406 detects an issue. In such a case, the model 406 may forward the detected issue to issue context generation engine 408, so as to obtain further context data regarding the issue. For example, the model 406 may send the anomalous KPI, the predicted KPI boundaries, any other measured or predicted KPIs, and the like, to issue context generation engine 408.

As shown, issue context generation engine 408 may maintain a large issue knowledge base 422 about the previously detected issues in the network of network entities 404 and/or any other networks monitored by service 302. In turn, issue context generation engine 408 may use the issue data received from the detecting model 406 and the issue data for previous issues stored in issue knowledge base 422 to:
cluster issues according to a proper similarity metric
select similar issues to extract context from.

In some cases, issue context generation engine 408 may do so by leveraging cross-learning across the various networks monitored by service 302. As pointed out previously, the ability to provide additional context based on similar issues experienced in other networks provides immense value to the user reviewing the newly detected issue and helps to resolve the issue.

To identify any similar issues as the one detected by the model 406, issue context generation engine 408 may extract a feature vector from the issue data provided to it by the model 406. The purpose of this transformation may be to achieve one or more of the following:
Remove any privacy sensitive information from the original feature vector. This is often a strict requirement n the case of comparing data across different networks.
Extract a set of features that can be easily used to compare different issues. For example, the absolute prediction by the model 406 can be replaced by issue context generation engine 408 as a deviation percentage, the actual values of the KPIs from the model 406 can be replaced by issue context generation engine 408 with a bit-vector identifying the relevant KPIs, etc.

In other words, the original issue feature vector produced by the detecting model 406 that represents the detected issue may, in some embodiments, be transformed by issue context generation engine 408 into an issue comparison feature vector. For example, such a comparison feature vector may utilize any or all of the following:

Examples of the components of this issue comparison feature vector are:

A one-hot encoding vector specifying the anomalous KPI(s) (e.g. abnormal onboarding time, wireless roaming failures, etc.)

A deviation percentage to represent the anomalous KPI(s)

KPI(s) capturing the network configuration (e.g., the number of APs in network entities 404 running a particular software release, the types of APs in network entities 404 and their model numbers, etc.).

Issue context generation engine 408 may perform similar transformations with respect to the previously detected network issues and store the resulting feature vectors in issue knowledge base 422. Thus, once the issue detected by the model 406 has been transformed by issue context generation engine 408, issue context generation engine 408 may compare the resulting comparison feature vector to those stored in issue knowledge base 422, to identify any similar issues.

More specifically, for each of the available feature comparison vectors, issue context generation engine 408 may maintain a metadata entry in issue knowledge base 422 that includes additional context information about the corresponding issue that can be relevant to the user reviewing the newly detected issue. Such metadata may include, for example, any or all of the following:

An issue relevance score that the user has attributed to that particular issue (notice that with cross learning the user can be another customer)

A user generated free-form issue description of the issue. For example, this may include some text that the user who experienced that issue provided to service 302, to describe his or her understanding of the issue itself (e.g., “excessive onboarding failure due to DHCP server crash,” etc.)

A user rating on the effectiveness of the remediation action(s) that were taken.

Selected KPI time series showing the issue impact (e.g., the throughput evolution during the issue, etc.)

Relevant network configuration information (e.g., no action has been taken, remediation consists in augmenting the DHCP pool, resolution rate was X %, etc.).

Optionally, user rating of the different suggested actions, as discussed further below (e.g., a user evaluation of whether a given suggested action has been effective in the past)

Note that a goal of the issue metadata in issue knowledge base 422 is to not leak any sensitive data, as it may be used across different networks operated by different organizations. Further, in some cases, issue knowledge base 422 may be partitioned based on the characteristics of the networks where the issues have been detected (e.g., based on vertical/industry, size, configuration, etc.). This would allow the new issue comparison feature vector generated by issue context generation engine 408 to be compared against the set of feature vectors generated for comparable networks.

Based on the distances between the feature comparison vectors, issue context generation engine 408 may select the closest feature vectors from issue knowledge base 422 to that of the newly detected issue. In another embodiment, issue context generation engine 408 can base this selection on the geometric distances between the vectors, weighted by the relevancy scores in their metadata entries in issue knowledge base 422. In addition, issue context generation engine 408 may employ a cutoff criterion (e.g., a feature vector distance threshold) to filter eligible issues in issue knowledge base 422 for contributing to a context for the newly detected issue. Of course, if the closest issue comparison feature vector in issue knowledge base 422 is too far (e.g., the distance to it s above the cutoff), issue context generation engine 408 may simply determine that no context data exists for the network issue detected by the model 406.

In various embodiments, issue context generation engine 408 may identify the similar network issues in issue knowledge base 422 to the newly detected issue by employing a clustering technique. For example, issue context generation engine 408 may apply clustering to the comparison feature vector for the newly detected issue to those in issue knowledge base 422, thereby grouping vectors into issue clusters based on their similarities. As a result, issue context generation engine 408 may deem any previously detected issues that are also in the issue cluster of the newly detected issue as being similar issues and of relevance.

Regardless of the selection technique used, issue context generation engine 408 may deem the similar network issues selected from issue knowledge base 422 as contextual issues for the newly detected network issue. In other words, while these are different issues that have been detected over time, their similarity to the newly detected issue can help give context to the issue to the user.

If issue context generation engine 408 finds a set of one or more similar/contextual issues within issue knowledge base 422, issue context generation engine 408 may construct an issue context message that can be forwarded to output and visualization interface 318 for presentation to a user via one or more user interfaces (UIs). For example, such a message may include any or all of the following context data:

both the issue comparison feature of the eligible contextual issues (this can include a list of KPIs, their deviations, etc.);

the issue freeform text description for each of the contextual issues;

a list of the actions undertaken by the user in order to remediate the issue; and/or

optionally, suggested action information (e.g., the suggested action selected by the user via the UI and an assessment of whether it was effective).

More specifically, as shown, issue context generation engine 408 may forward the issue context message to context visualization engine 412, whose function is to provide the contents of this message to the user via a UI. In addition, in some embodiments, context visualization engine 412 may also seek feedback from the user via the UI regarding the newly detected network issue. In other words, in addition to providing additional context for the detected issue, context visualization engine 412 may also ask the user to indicate any relevant context for the newly detected issue, as well. This allows the specified context to also be stored in issue knowledge base 422, to aid in providing context for future issues that a model 406 may detect. In other words, the context data stored in issue knowledge base 422 may be crowdsourced across any number of user and across any number of networks or organizations. For example, the user may be asked to provide an issue relevance score, a freeform description of the issue, and the like.

In another embodiment, context visualization engine 412 may assess the freeform issue description specified by the user to identify any potential issue relevant information. For example, context visualization engine 412 can use regular expressions to detect IP and MAC addresses in the description specified by the user for the newly detected network issue.

Optionally, context visualization engine 412 can also collect additional telemetry and configuration information for inclusion in the context data provided to the user interface regarding the detected network issue. For example, context visualization engine 412 may collect telemetry information for computing the contextual issue timeseries, configuration information from network entities 404, or the like. Such information can further aid the user in assessing the detected network issue and can aid in root cause analysis.

After providing an indication of the detected issue and its context to the UI, context visualization engine 412 may receive an issue context feedback message from the UI that includes any or all of the following:
The confidence index and freeform text provided by the user for the newly detected issue
The list of actions undertaken by the user to address the issue
Optionally, feedback concerning the effectiveness of such remediation action(s)

In turn, context visualization engine 412 may send the context feedback message to issue context generation engine 408, along with any telemetry data collected by context visualization engine 412, thereby allowing issue context generation engine 408 to add a new entry in issue knowledge base 422 for the newly detected issue. In another embodiment, issue context generation engine 408 may control whether to add the issue and its context to issue knowledge base 422, based on the context feedback message. For example, if the user specified a low relevance score for the detected issue, issue context generation engine 408 may opt to not add a corresponding entry in issue knowledge base 422.

In yet another embodiment, issue context generation engine 408 may control the addition of any new issues and their context to issue knowledge base 422 based on a diversity criterion, to avoid too many issues in some regions of the issue comparison feature space. In other words, issue context generation engine 408 may prevent too many entries being entered into issue knowledge base 422 for “similar” issues that are already there. Indeed, an unbalanced dataset of issue contexts, over-representing some regions of the feature space, can lead to biased results.

At this point, context visualization engine 412 may seek further feedback from the user via the UI so as to determine whether the additional context data provided in conjunction with the issue detection alert was useful. Such feedback can then be used by issue context generation engine 408 to tune the similarity/clustering mechanism of issue context generation engine 408. For example, issue context generation engine 408 may adjust the distance that it uses to select similar issues, in an attempt to increase the rate of positive feedback regarding the context data that service 302 provides with detected network issues.

A further component of architecture 400 is issue characterization engine 410. As would be appreciated, this component, as with the other sub-components of ML-based analyzer 312, may be implemented as part of cloud service 302 or on-premise of the local network in which network entities 404 are located, depending on whether the issue is detected locally or in the cloud. In various embodiments, the purpose of issue characterization engine 410 is to describe the raised network issue as a feature vector, using the information obtained by the components described previously. Examples of such features may include, but are not limited to, any or all of the following:
Issue root cause
Issue type (e.g., onboarding time, success rate of joining the network, application performance issues, etc.)
Relevant KPIs such as onboarding times, DHCP/AAA times, etc.
Network configuration parameters (e.g. release of software running on a WLC, model type, etc.)
Network characterization parameters (e.g., size, vertical/industry, software/hardware versions etc.)
   Issue characterization engine 410 then exports the resulting vector to issue features reporter 414 as an issue features report.

In various embodiments, issue features reporter 414 may use the issue feature report received from issue characterization engine 410 to search action knowledge base 424 for a set of one or more actions that have already solved a similar issue. To do so, issue features reporter 414 may leverage clustering, to group the newly detected network issue with other, similar issues that were previously detected by service 302. As would be appreciated, this may be achieved using the same approach as issue generation engine 408 or a different approach, as desired. For example, in one embodiment, the functionalities of issue context generation engine 408 and issue features reporter 414 may be combined, to identify the previously detected network issues that are similar to the newly detected one. In another embodiment, issue context generation engine 408 and issue features reporter 414 may use different measures of similarity and/or different approaches, to identify the similar issues. For example, issue context generation engine 408 may use a much narrower notion of similarity for purposes of identifying context data than issue features reporter 414 uses for purposes of suggesting actions, or vice-versa. Further, while issue features reporter 414 is shown implemented as part of output and visualization interface 318, its functionality can also be implemented as part of ML-based analyzer 312.

In various embodiments, issue features reporter 414 may use clustering on the newly detected issue and those stored in action knowledge base 424. For example, issue features reporter 414 may use Density-Based Spatial Clustering of Applications with Noise (DBSCAN), or other clustering techniques, on the vector representations of the issues. Doing so allows issue features reporter 414 to assign different weights to different features, which can aid in the clustering as not all features will have the same importance with respect to the similarity assessment. For example, two issues may be more similar if they both relate to social media throughput issues in a dense wireless network than two issues that involve similar equipment but relate to different types of anomalies. In one embodiment, issue features reporter 414 can learn these weights automatically based on the information about suggested actions and their effectiveness. Indeed, issue features reporter 414 can use the information about suggested actions and their effectiveness on fixing the issue for merging and splitting existing clusters and, therefore, optimize the weights of the features in such a way that the clusters are generated as expected.

By way of example, when issue features reporter 414 receives an issue features report from issue characterization engine 410, issue features reporter 414 may attribute its corresponding network issue to one of the issue clusters from action knowledge base 424. In greater detail, issue features reporter 414 may:
Attribute the issue to a cluster based on the feature vector distance.
Select an optimal set of one or more suggested actions from action knowledge base 424 based on the suggested actions attributed to the other issues in the issue cluster. This can be done, for example, by performing a majority voting among the issues in the cluster, where the vote of each issue is weighted by the confidence index attributed to each set of suggested actions. Of course, one skilled in the art could implement other selection approaches, as well.
Attribute a confidence index to the set of one or more suggested actions based on the distance among the incoming issue and the cluster and the confidence index of the selected set of suggested action(s).
If no suitable cluster can be found by issue features reporter 414 (i.e., the newly detected issue is not similar enough to any of the issue clusters already present in action knowledge base 424), issue features reporter 414 may send a no suggested action message that includes a list of statically defined suggested actions and an attribute confidence index of 0 assigned to them. In another embodiment, issue features reporter 414 may request, via the UI, that the user manually define the set of suggested action(s) to be associated with the detected issue.

During system bootstrap, no suggested actions information will be available. In this case, one or more human experts may provide the required knowledge via the UI(s). This will be required until enough information is acquired in action knowledge base 424 (i.e., a sufficient set of suggested actions is available for each cluster). Also, issue features reporter 414 may periodically re-cluster the issues in action knowledge base 424 as more points are added or in response to a request from the UI to do so.

Once issue features reporter 414 has identified the set of one or more suggested actions associated with the issue cluster to which the detected network issue is associated, issue features reporter 414 may generate and send a suggested actions list message that is indicative of the selected action(s). In some embodiments, the suggested actions can also be specified as templates that can be further populated with network-specific information regarding the network issue. For example, one of the templates may be of the form “Check DUCT server <server IP>,” where <server IP> is a tillable field that is populated by issue features reporter 414 with the IP address of the DHCP server associated with the detected network issue.

At this point, issue features reporter 414 may provide any or all of the following information to suggested actions display engine 416 via a suggested actions list message:
A representative issue type: this information summarizes the detected issue for which the suggested action(s) are provided. Said differently, the representative issue summarizes the information of the related issue cluster. For example, issue features reporter 414 may include information regarding the feature vector of the centroid of the issue cluster, or the like.
The set of one or more selected actions.

More specifically, when suggested actions display engine 416 receives a suggested actions list message (or a no actions list message) from issue features reporter 414, suggested actions display engine 416 may perform any or all of the following:
Fill in any of the specific values required by suggested actions templates (e.g., is leveraging network data collection platform 304 or another mechanism, as needed).
Provide the suggested action(s) or other information from issue features reporter 414 to the UI for review by the user. For each suggested action, suggested actions display engine 416 may provide the representative issue and set of suggested action(s). The aim of the representative issue is to allow for the potential rejection of an action by the user. Indeed, the user may decide that the set of suggested action(s) correspond to issues that are not similar to the issue that was raised.
For each suggested action, suggested actions display engine 416 may also provide an indication of its success rate, which indicates the percentage of times the suggested action managed to indeed fix the type of issue.
Asks the user to provide some feedback about the effectiveness of the selected action(s).
In another embodiment, suggested actions display engine 416 may evaluate the effectiveness of the suggested action by examining network telemetry data.
Send a suggested actions feedback message to action knowledge base 424 with the user-provided information such as the specific action selected by the user to be taken and its confidence score (e.g., as expressed as a user-specified score).
the confidence score is above a specified threshold (i.e., the suggested action has worked well enough) the issue will be added as a new data point to action knowledge base 424.

While the techniques herein are quite effective at enhancing the machine learning-detected network issues from the standpoint of a user, further embodiments provide for any or all of the information sent to the UI to be sent to another component in the network instead of or in addition thereto. For example, any or all of the information that may be sent to the UI for review can be sent to automation and feedback controller 316 (e.g., to implement the selected one or more actions to address the detected network issue, etc.).

In some embodiments, suggested actions display engine 416 may interact with automation and feedback controller 316 to automatically enforce any of the suggested action(s) that the user wishes to enforce. In particular, the user can select an option to have the selected action automatically enforced and suggested actions display engine 416 may send a corresponding instruction to automation and feedback controller 316 to do so. In turn, automation and feedback controller 316 may send the appropriate control commands 338 back to the monitored network, to implement the action(s). For example, if the action entails increasing the size of the DHCP address pool used by the DHCP server, controller 316 can automatically perform such configuration action (e.g., if the percentage of success indicated by the system for similar issues exceeds a percentage of success).

Optionally, architecture 400 may also include actions evaluation engine 418 that is configured to evaluate the impact of a suggested action on network performance indexes. The output of actions evaluation engine 418 can be sent to suggested actions display engine 416, to contribute to the action confidence index computation. In particular, assume that a model 406 has detected a throughput issue in the monitored network. In such a case, actions evaluation engine 418 can forward this information to the UI (e.g., as a plot displaying the throughput variation after the actions have been enforced). To do so, actions evaluation engine 418 may assess telemetry data such as WLC telemetry data, Netflow or IPFIX records, SNMP data, or the like, as collected by network data collection platform 304.

In various embodiments, if the confidence indices assigned to the set of action(s) are high enough, and the user has enough trust in the suggested action system, automatic enforcement of the action(s) can be initiated. To this end, architecture 400 may also include a user trust engine 420.

During execution, user trust engine 420 may monitor the confidence score that the user attributes to each of the action(s) suggested by suggested actions display engine 416 for the detected network issue. Based on the time series of such confidence scores, user trust engine 420 may compute a user trust score. In another embodiment, user trust engine 420 may monitor the percentage of times the user actually opts for service 302 to automatically enforce suggested actions. Note that the trust score differs from the confidence indices assigned to the actions in that the trust score reflects the degree of trust the user has in the actions suggested by service 302.

In another embodiment, user trust engine 420 may compute the trust score for the user separately by issue category (e.g., throughput issues, onboarding issues etc.). For example, the user of the UI may often agree to have service 302 initiate the suggested actions for throughput issues, but often elects to manually address onboarding issues. By computing different trust scores by issue type, this allows service 302 to automatically address only certain types of issues detected in the future, based on their type, while simply informing the user of other types of issues detected in the future.

Accordingly, in various embodiments, if a user trust score exceeds a predefined threshold, user trust engine 420 may send a message to suggested actions display engine 416 that causes engine 416 to send an option to the UI to enable automatic enforcement of actions in the network for future network issues detected by service 302. If the user accepts such a proposition, suggested actions display engine 416 may start forwarding the suggested actions list (potentially on a per-issue type basis) to automation and feedback controller 316 for automatic enforcement without first waiting for approval from the user.

In another embodiment, the user can select, via the UI, a threshold confidence score value which will be used by suggested actions display engine 416 to decide which actions can be automatically enforced and which suggestions will just be proposed to the user via the UI before enforcement.

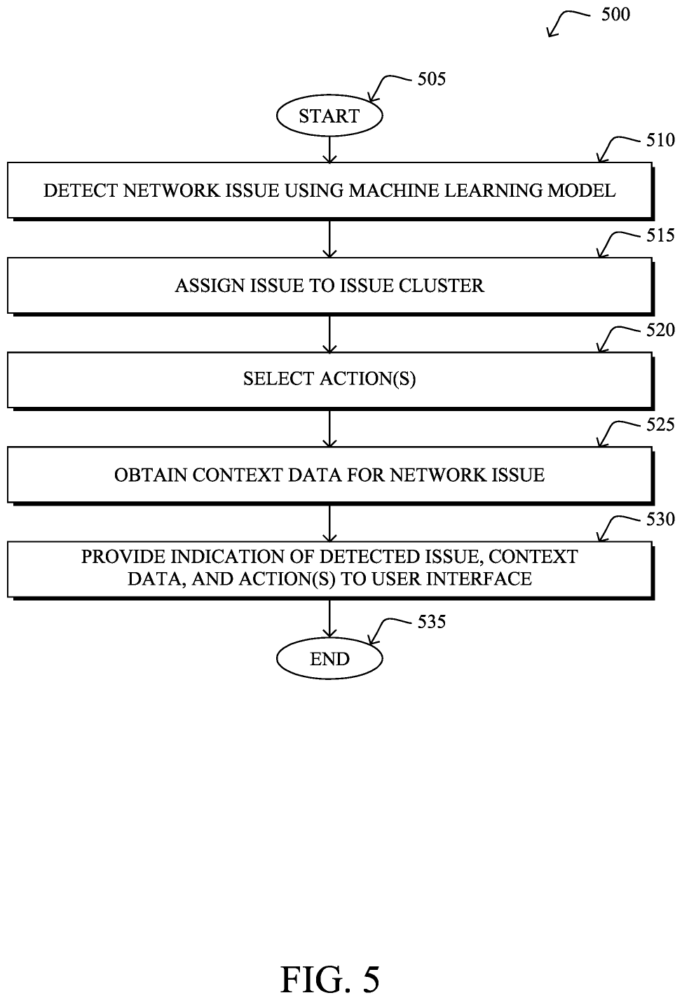

FIG. 5 illustrates an example simplified procedure for determining context and actions for machine learning-detected network issues, in accordance with one or more embodiments described herein. For example, a non-generic, specifically configured device (e.g., device 200) may perform procedure 500 by executing stored instructions (e.g., process 248), to provide a network assurance service to a monitored network. The procedure 500 may start at step 505, and continues to step 510, where, as described in greater detail above, the service may detect a network issue in the network using a machine learning model based on telemetry data captured in the network. For example, such an issue may correspond to an anomalous amount of onboarding failures, onboarding times, delays, jitter, packet drops, client counts, or any other KPI regarding the network.

At step 515, as detailed above, the service may assign the detected network issue to an issue cluster by clustering the detected network issue and to a plurality of previously detected network issues. In some embodiments, the plurality of previously detected network issues comprise at least one network issue detected in another network. In other words, the network assurance service may be executed in a central location, such as in the cloud, to monitor any number of networks and group them according to their data features. In further embodiments, the service may represent the network issue and the other detected issues as feature vectors indicative of any number of observed KPIs in the telemetry data from the network, predicted KPIs by the machine learning model, a deviation between the two, or other information that can be used to represent the issues.

At step 520, the service may select a set of one or more actions for the detected network issue from among a plurality of actions associated with the previously detected network issues in the issue cluster, as described in greater detail above. In some embodiments, the service may base the selection on confidence indices assigned to one or more of the plurality of actions associated with the previously detected network issues in the issue cluster. In general, these confidence indices represent how well the corresponding action is expected to address the detected network issue. For example, the service may compute vote scores for the previously detected network issues that are weighted based on the confidence indices assigned to the action(s). In turn, the service may select the action(s) having the highest vote scores.

At step 525, as detailed above, the service may obtain context data for the detected network issue. In general, such context data helps to describe the detected network issue to an end user. For example, the context data may be indicative of at least one of: a relevance score, a user-defined description, an action rating for an action in the selected set of one or more actions, or network configuration information for the network. In some embodiments, the service may derive some or all of the context data from context data associated with one or more other network issues in the issue cluster. Thus, context can be provided immediately to the user based on context data associated with previously detected network issues in the same network and/or in other, similar networks.

At step 530, the service may provide, to a user interface, an indication of the detected network issue, the context data for the detected network issue, and the selected set of one or more actions. In turn, in some embodiments, the service may receive an instruction to automatically enforce the selected set of action(s) and, after receiving the instruction, initiate performance of the selected action(s). In further embodiments, the service may compute a trust score based on the received instruction and send an option to the user interface, to allow the user to enable automatic enforcement of actions in the network for future network issues detected by the service. Of course, the user could also reject the set of one or more actions. In such a case, the service may adjust the confidence indices assigned to the one or more actions based on the rejection. Procedure 500 then ends at step 535.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce approaches that allow a machine learning-based network assurance service to also provide context data and suggested actions to a user, when the service detects a network issue. This allows the user to better understand the issue, as well as to initiate corrective actions, if desired.

While there have been shown and described illustrative embodiments that provide for determining context and actions for machine learning-detected network issues, it is to be understood that various other adaptations and modifications may be made within the spirit and scope of the embodiments herein. For example, while certain embodiments are described herein with respect to using certain models for purposes of anomaly detection and forecasting network KPIs, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
detecting, by a network assurance service that monitors a network, a network issue in the network using a machine learning model and based on telemetry data captured in the network;
representing, by the network assurance service, the detected network issue and a plurality of previously detected network issues as feature vectors;
assigning, by the network assurance service, the detected network issue to an issue cluster by applying clustering to the feature vectors that represent the detected network issue and the plurality of previously detected network issues;
selecting, by the network assurance service, a set of one or more actions for the detected network issue from among a plurality of actions associated with the previously detected network issues in the issue cluster;
obtaining, by the network assurance service, context data for the detected network issue; and
providing, by the network assurance service and to a user interface, an indication of the detected network issue, the context data for the detected network issue, and the selected set of one or more actions.

2. The method as in claim 1, wherein the feature vectors are indicative of one or more of: a key performance indicator (KPI) from the telemetry data captured in the network, a KPI predicted by the machine learning model, or an amount of deviation between a KPI from the telemetry data and a KPI predicted by the machine learning model.

3. The method as in claim 1, wherein the context data for the detected network issue is indicative of at least one of: a relevance score, a user-defined description, an action rating for an action in the selected set of one or more actions, or network configuration information for the network.

4. The method as in claim 1, wherein the plurality of previously detected network issues comprise at least one network issue detected in another network.

5. The method as in claim 1, wherein the set of one or more actions are selected based on confidence indices assigned to one or more of the plurality of actions associated with the previously detected network issues in the issue cluster.

6. The method as in claim 5, wherein selecting the set of one or more actions for the detected network issue from among the plurality of actions associated with the previously detected network issues in the issue cluster comprises:
computing vote scores for each of the previously detected network issues, wherein the vote scores are weighted based on the confidence indices assigned to the one or more of the plurality of actions; and
selecting the set of one or more actions using the computed vote scores.

7. The method as in claim 1, further comprising:
receiving, at the network assurance service and via the user interface, an instruction to automatically enforce the selected set of one or more actions in the network for the detected network issue; and
initiating, by the network assurance service and after receiving the instruction, performance of the selected set of one or more actions in the network.

8. The method as in claim 7, further comprising:
computing, by the network assurance service, a trust score based on the received instruction to automatically enforce the selected set of one or more actions in the network; and
sending, by the network assurance service and to the user interface, an option to enable automatic enforcement of actions in the network for future network issues detected by the network assurance service.

9. The method as in claim 1, further comprising:
receiving, at the network assurance service and from the user interface, a rejection of the set of one or more actions; and
adjusting, by the network assurance service, confidence indices assigned to the one or more actions based on the rejection.

10. An apparatus, comprising:
one or more network interfaces;
a processor coupled to the network interfaces and configured to execute one or more processes; and
a memory configured to store a process executable by the processor, the process when executed configured to:
detect a network issue in a network using a machine learning model and based on telemetry data captured in the network;
represent the detected network issue and a plurality of previously detected network issues as feature vectors;
assign the detected network issue to an issue cluster by applying clustering to the feature vectors that represent the detected network issue and the plurality of previously detected network issues;
select a set of one or more actions for the detected network issue from among a plurality of actions associated with the previously detected network issues in the issue cluster;
obtain context data for the detected network issue; and
provide, to a user interface, an indication of the detected network issue, the context data for the detected network issue, and the selected set of one or more actions.

11. The apparatus as in claim 10, wherein the feature vectors are indicative of one or more of: a key performance indicator (KPI) from the telemetry data captured in the network, a KPI predicted by the machine learning model, or an amount of deviation between a KPI from the telemetry data and a KPI predicted by the machine learning model.

12. The apparatus as in claim 10, wherein the context data for the detected network issue is indicative of at least one of: a relevance score, a user-defined description, an action rating for an action in the selected set of one or more actions, or network configuration information for the network.

13. The apparatus as in claim 10, wherein the plurality of previously detected network issues comprise at least one network issue detected in another network.

14. The apparatus as in claim 10, wherein the set of one or more actions are selected based on confidence indices assigned to one or more of the plurality of actions associated with the previously detected network issues in the issue cluster.

15. The apparatus as in claim 14, wherein the apparatus selects the set of one or more actions for the detected network issue from among the plurality of actions associated with the previously detected network issues in the issue cluster by:
computing vote scores for each of the previously detected network issues, wherein the vote scores are weighted based on the confidence indices assigned to the one or more of the plurality of actions; and
selecting the set of one or more actions using the computed vote scores.

16. The apparatus as in claim 10, wherein the process when executed is further configured to:
receive, via the user interface, an instruction to automatically enforce the selected set of one or more actions in the network for the detected network issue; and
initiate, after receiving the instruction, performance of the selected set of one or more actions in the network.

17. The apparatus as in claim 16, wherein the process when executed is further configured to:
compute a trust score based on the received instruction to automatically enforce the selected set of one or more actions in the network; and
send, to the user interface, an option to enable automatic enforcement of actions in the network for future network issues detected by the apparatus.

18. The apparatus as in claim 10, wherein the process when executed is further configured to:
receive, from the user interface, a rejection of the set of one or more actions; and
adjust confidence indices assigned to the one or more actions based on the rejection.

19. A tangible, non-transitory, computer-readable medium storing program instructions that cause a network assurance service to execute a process comprising:
detecting, by the network assurance service that monitors a network, a network issue in the network using a machine learning model and based on telemetry data captured in the network;
representing, by the network assurance service, the detected network issue and a plurality of previously detected network issues as feature vectors;
assigning, by the network assurance service, the detected network issue to an issue cluster by applying clustering to the feature vectors that represent the detected network issue and the plurality of previously detected network issues;
selecting, by the network assurance service, a set of one or more actions for the detected network issue from among a plurality of actions associated with the previously detected network issues in the issue cluster;
obtaining, by the network assurance service, context data for the detected network issue; and
providing, by the network assurance service and to a user interface, an indication of the detected network issue, the obtained context data for the detected network issue, and the selected set of one or more actions.

20. The computer-readable medium as in claim 19, wherein the set of one or more actions are selected based on confidence indices assigned to one or more of the plurality of actions associated with the previously detected network issues in the issue cluster.
